(19) United States
(12) Patent Application Publication
(10) Pub. No.: US 2026/0219914 A1
(43) Pub. Date: Jul. 30, 2026

(54) HOST REIMAGING FOR ORCHESTRATION AND MANAGEMENT OF HETEROGENOUS COMPUTING RESOURCES

(71) Applicant: Hewlett Packard Enterprise Development LP, Spring, TX (US)

(72) Inventors: David Rabon Estes, Westfield, IN (US); Brian David Wheeler, Cherry Hills Village, CO (US)

(21) Appl. No.: 19/041,773

(22) Filed: Jan. 30, 2025

(51) Int. Cl. G06F 9/455

(52) U.S. Cl. CPC G06F 9/45558; G06F 2009/45591; G06F 2009/45595

(57) ABSTRACT

The present disclosure provides techniques for reimaging physical hosts from a first hypervisor to a second hypervisor. A method includes designating one of a plurality of physical hosts as a coordinating host, receiving a service request to reimage target hosts, obtaining installation media for the second hypervisor, and installing the second hypervisor on each target host. The installation is performed by streaming the installation media from the coordinating host to each of the target hosts. The method enables efficient transition between different hypervisors across multiple physical hosts in a coordinated manner.

### CROSS-REFERENCE TO RELATED APPLICATIONS

This application is related to co-pending U.S. Patent Application Nos. _ and _, filed on the same day as this application, each entitled “Host Reimaging for Orchestration and Management of Heterogenous Computing Resources” and associated with Attorney Docket Nos. P176613US and P176615US, respectively which applications are hereby incorporated by reference herein in their entirety.

### BACKGROUND

Cloud computing has revolutionized the way organizations manage and deploy IT resources. By providing on-demand access to a shared pool of configurable computing resources, cloud platforms enable organizations to rapidly scale their infrastructure and services without needing large upfront investments in hardware. These resources can include virtual machines, storage, networking, databases, and various software applications and services.

The cloud computing model typically encompasses several service categories, including Infrastructure as a Service (IaaS), Platform as a Service (PaaS), and Software as a Service (SaaS). IaaS provides virtualized computing resources over the internet, allowing users to rent virtual machines, storage, and networking. PaaS offers a platform for developers to build, run, and manage applications without the complexity of maintaining the underlying infrastructure. SaaS delivers software applications over the internet, eliminating users needing to install and run the applications on their computers or infrastructure.

As cloud adoption has grown, many organizations have embraced hybrid and multi-cloud strategies. Hybrid cloud environments combine public and private cloud resources, allowing businesses to keep sensitive data on-premises while leveraging the scalability and cost-effectiveness of public clouds for other workloads. Multi-cloud approaches involve using services from multiple cloud providers, which can help avoid vendor lock-in and optimize for specific capabilities offered by different platforms.

The management and orchestration of resources across diverse cloud environments can present significant challenges for organizations. Various tools and platforms have emerged to address these challenges. However, the rapidly evolving nature of cloud services and the increasing complexity of enterprise IT landscapes continue to present ongoing challenges in this domain.

### BRIEF DESCRIPTION OF THE DRAWINGS

For a more complete understanding of this disclosure, and advantages thereof, reference is now made to the following descriptions taken in conjunction with the accompanying drawings.

FIG. 1 is a block diagram of a cloud computing management environment, according to some implementations.

FIG. 2 is a block diagram of hardware components of the management platform, according to some implementations.

FIG. 3 is a block diagram of the software architecture of the management environment, according to some implementations.

FIG. 4 is a block diagram of a management method, according to some implementations.

FIG. 5 is a block diagram of a cloud computing management environment, according to some implementations.

FIGS. 6A-6D are block diagrams of intermediate steps in a reimaging process for a plurality of physical hosts, according to some implementations.

FIG. 7 illustrates a flowchart of a host reimaging method, according to some implementations.

FIG. 8 illustrates a flowchart of a host reimaging method, according to some implementations.

FIG. 9 illustrates a flowchart of a host reimaging method, according to some implementations.

FIG. 10 illustrates a flowchart of a host reimaging method, according to some implementations.

Corresponding numerals and symbols in the different figures generally refer to corresponding parts unless otherwise indicated.

### DESCRIPTION

The following disclosure provides many different examples for implementing different features. Specific examples of components and arrangements are described below to simplify the present disclosure. These are, of course, merely examples and are not intended to be limiting.

Modern enterprise IT environments often encompass heterogeneous computing resources spanning multiple cloud providers, on-premises infrastructure, and various software-as-a-service offerings. Managing and orchestrating these diverse resources may present challenges for organizations. One particular challenge arises when an organization obtains new physical hosts (e.g., servers) pre-installed with system software (e.g., an operation system or hypervisor) that does not align with the organization’s preferred infrastructure. This may involve reimaging multiple hosts with the desired system software, which can be time-consuming and may require manual intervention.

This disclosure describes systems and methods for reimaging multiple physical hosts from one hypervisor to another in a coordinated manner. The approach may leverage a designated coordinating host, which may be one of the physical hosts, to orchestrate the reimaging process across multiple target hosts. The coordinating host may streamline the transition to the desired system software and reduce the complexity of setting up a computing environment. The coordinating host may also be reimaged as part of this process, by another host, after the coordinating host reimages the other target hosts. The reimaging process may use baseboard management controllers (BMCs) of the hosts.

In some aspects, the system may designate one of the physical hosts as a coordinating host to manage the reimaging process. The coordinating host may receive a service request to reimage target hosts from a first hypervisor to a second hypervisor. In response, the coordinating host may obtain installation media for the second hypervisor and stream this media to the baseboard management controller of each target host, facilitating the installation of the new hypervisor across multiple hosts simultaneously. Installation may be accomplished by having each baseboard management controller mount the streamed installation media as a virtual drive within its host. A baseboard management controller may then reboot the physical host and configure it to boot from the mounted installation media, allowing for an automated installation of the new hypervisor.

In some aspects, the system may allow for dynamic configuration of each target host during the reimaging process. The service request received by the coordinating host may include specific configuration parameters for each target host. As the coordinating host streams the installation media to each target host, it may embed a respective reimaging configuration within the media streamed to the respective target host. This configuration may be in the form of an unattended install file that is unique to each host. Embedding host-specific configurations in this manner may enable customized media configurations for each host while maintaining an efficient, centralized reimaging process. This approach may reduce space requirements by eliminating the need for duplicate copies of installation media with different reimaging configurations.

In some aspects, the system may provide a handover process for reimaging of the coordinating host itself. After installing the new hypervisor on the target hosts, the coordinating host may configure a management and orchestration service on one of the reimaged target hosts. This service may then take over the coordination role. The service may reimage the original coordinating host with the new hypervisor in a similar manner as the other hosts, such as by providing an image with embedded reimaging configuration to the coordinating host. Thus, each desired host (including the initial coordinating host) may be transitioned to the desired hypervisor without manual intervention.

The systems and methods may provide several advantages for organizations managing complex IT environments. By automating the reimaging process, organizations may reduce the time and effort required to transition multiple physical hosts to a new hypervisor. The ability to dynamically configure each host during reimaging may allow for customization without manual intervention. Furthermore, the seamless handover process may help ensure all desired hosts are reimaged. These capabilities may allow an organization to efficiently set up a new infrastructure from bare metal, potentially accelerating the deployment of a new computing environment.

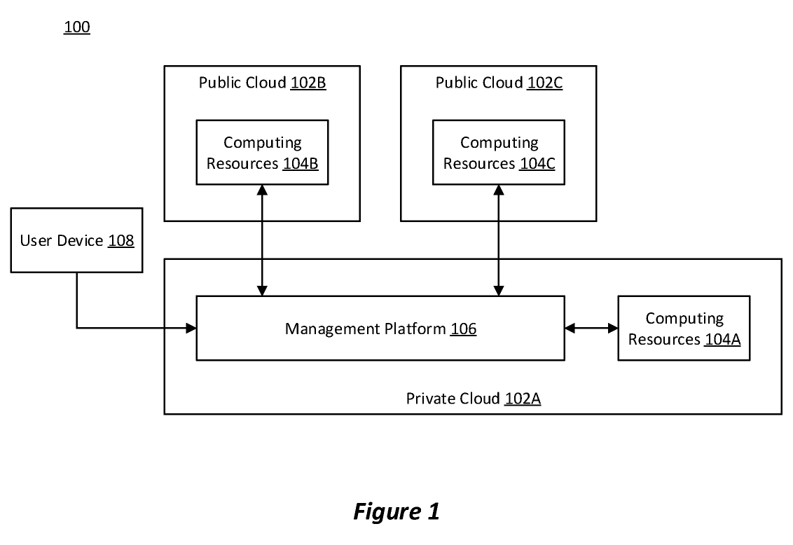

FIG. 1 is a block diagram of a cloud computing management environment 100, according to some implementations. The management environment 100 may include multiple clouds 102 (including a private cloud 102A and one or more public clouds 102B, 102C), a management platform 106, and a user device 108. This architecture represents a hybrid cloud approach for an organization, combining private and public cloud resources under centralized management while maintaining data privacy and security.

The private cloud 102A may be a privately accessible computer network under the organization’s control. In some aspects, it may provide dedicated computing resources and infrastructure that are not shared with other organizations. The private cloud 102A may offer enhanced security and customization options compared to public cloud offerings. In some cases, it may allow the organization to maintain sensitive data and critical workloads on-premises while still leveraging cloud technologies and architectures. The private cloud 102A may be managed and operated by the organization’s IT staff, providing greater control over resource allocation, security policies, and compliance measures.

The public clouds 102B, 102C may be publicly accessible computer networks operated by cloud providers. In some aspects, they may provide shared computing resources and infrastructure that can be utilized by multiple organizations. The public clouds 102B, 102C may offer organizations scalable and on-demand access to computing power, storage, and various services. In some cases, they may allow organizations to rapidly provision resources without large upfront investments in hardware and infrastructure. The public clouds 102B, 102C may be managed and operated by third-party cloud service providers, offering services and APIs for resource allocation and management. In some implementations, they may provide built-in redundancy and geographic distribution of resources to enhance reliability and performance. The public clouds 102B, 102C may be operated by different service providers, allowing organizations to leverage the unique strengths and capabilities of multiple cloud platforms.

The clouds 102 include computing resources 104 (e.g., computing resources 104A, computing resources 104B, and computing resources 104C for, respectively, the private cloud 102A, the public cloud 102B, and the public cloud 102C). The computing resources 104 may include various types of resources that can be utilized to perform computational tasks, store data, and the like. In some aspects, these resources may include virtual machines, containers, serverless functions, storage volumes, databases, networking components, and other cloud-based services. The computing resources 104 may be dynamically scalable, allowing for flexible allocation based on demand. In some cases, the computing resources 104 may include specialized hardware such as GPUs for machine learning tasks or FPGAs for custom acceleration. The computing resources 104 may also encompass platform services like managed Kubernetes clusters, serverless platforms, or IoT device management systems. Additionally, the computing resources 104 may include software-defined infrastructure components that can be programmatically controlled and configured. The specific types and configurations of computing resources 104 may vary between the private cloud 102A and public clouds 102B and 102C, reflecting the different capabilities of each environment.

The management platform 106 may serve as a central control point in the management environment 100, coordinating interactions between the various components (including the computing resources 104). In some implementations, the management platform 106 may be deployed within the private cloud 102A. In other implementations, the management platform 106 may be deployed within another part of an organization. The management platform 106 may control the computing resources 104A within the private cloud 102A and the computing resources 104B, 104C in the public clouds 102B, 102C. Specifically, the management platform 106 may send instructions to and receive information from the computing resources 104, which may allow for efficient allocation and management of resources across the clouds 102.

In some cases, the hybrid architecture of the management environment 100 may enable the organization to maintain sensitive workloads and data within their private cloud 102A while leveraging the scalability and cost-effectiveness of public clouds 102B, 102C for other operations. The management platform 106 may provide a unified view of the computing resources 104, regardless of location, allowing for consistent policies and management practices across the entire environment.

The user device 108 may be connected to the management platform 106, allowing users to interact with and control the management platform 106. This may enable administrators to manage computing resources 104 across private and public clouds from a single interface, streamlining operations and reducing complexity. This may also enable end-users (e.g., non-administrators) to access computing resources 104 as permitted by their roles and permissions. Specifically, the management platform 106 may provide self-service capabilities for end-users to provision and manage resources within defined policies and limits set by administrators.

The management platform 106 may provide a unified view of resources across multiple cloud providers and on-premises infrastructure. This unified view may allow an administrator using a user device 108 to monitor and manage the computing resources 104 across the private cloud 102A and public clouds 102B, 102C from a single interface. In some aspects, the management platform 106 may aggregate data from various sources and present it in a consistent, normalized format, enabling users to easily compare and analyze resource utilization across different environments. The normalization process may involve transforming definitions for provider-specific computing resources 104 into defined schemas, creating a standardized representation of diverse resource types. This transformation may allow the management platform 106 to handle heterogeneous data from different cloud providers and on-premises systems uniformly. The defined schemas may capture the requisite attributes and relationships of resources, enabling the platform to maintain a coherent view of the entire infrastructure landscape. By normalizing the data, the management platform 106 may facilitate cross-provider comparisons, simplify resource management tasks, and provide a foundation for advanced analytics and optimization strategies.

In addition to unified visibility, the management platform 106 may offer unified control of the computing resources 104. The platform may leverage APIs provided by the computing resources 104 to enable centralized management and orchestration. This unified control may allow administrators to perform actions such as provisioning, scaling, and configuring resources across multiple environments from a single point of control. The management platform 106 may abstract away the particularities of individual provider interfaces, presenting a consistent set of management operations that can be applied across heterogeneous computing resources 104. This unified control approach may streamline management and orchestration operations, including day-2 operations.

The management platform 106 may discover and inventory computing resources 104 across the clouds 102. This discovery process may involve periodic scanning and synchronization to maintain an up-to-date view of available resources. The platform may automatically detect new resources, changes to existing resources, and resource removals across both private cloud 102A and public clouds 102B, 102C. The discovered computing resources 104 may be mapped to a normalized data model (subsequently described) for the platform, enabling consistent representation regardless of the source cloud. The discovery process may capture detailed metadata about computing resources 104, including relationships between resources, configuration settings, and operational state. This comprehensive resource discovery may enable the management platform 106 to maintain an accurate inventory of infrastructure components and their dependencies across the entire management environment 100.

The management platform 106 may manage user access and authentication within the system. This functionality may allow administrators to control the resources and capabilities end-users can access through the user devices 108. The platform may implement role-based access control (RBAC) to define and manage user permissions across the entire management environment 100, ensuring that users are limited to having access to the resources and functions appropriate for their roles. In some implementations, the management platform 106 may layer a user authentication and authorization framework over existing frameworks (if any) of the computing resources 104. For example, the management platform 106 may have a master API key to a computing resource 104 and may control how the computing resources 104 are accessed by users based on its own authentication and authorization system. The platform may map user identities and roles across different systems, providing a unified access model that spans heterogeneous environments. In some cases, the management platform 106 may integrate with existing authentication systems, enabling single sign-on capabilities.

The management platform 106 may implement a comprehensive security and compliance framework across the management environment 100. This framework may include automated security scanning of computing resources 104, continuous compliance monitoring, and policy enforcement during resource provisioning and management. The platform may integrate with security tools and services to perform vulnerability assessments, configuration audits, and security monitoring of resources across clouds 102. In some implementations, the management platform 106 may enforce security policies during provisioning, automatically configuring security controls and validating compliance requirements as resources are deployed. The platform may maintain audit trails of actions performed on computing resources 104, enabling organizations to track changes and demonstrate compliance with security requirements. Security policies may be defined and enforced consistently across the private cloud 102A and the public clouds 102B, 102C, ensuring uniform security controls regardless of resource location.

The management platform 106 may provide self-service capabilities to users of the user device 108. An end-user may request and provision resources through a user device 108 within predefined limits and policies set by administrators. In some aspects, the management platform 106 may present different interfaces or options to users based on their roles or permissions, allowing for customized self-service experiences while ensuring compliance with organizational policies. The self-service capabilities may be constrained by configuration settings defined within the management platform 106 by the organization. For example, administrators may set resource quotas, cost thresholds, or approved computing resources 104 that limit what end-users can provision. The management platform 106 may enforce these constraints automatically when processing self-service requests. Additionally, the management platform 106 may provide approval workflows for certain requests requiring additional authorization before provisioning. This allows organizations to enable user-driven provisioning while maintaining appropriate governance and control over resource usage. The platform may support contextually aware deployments, considering user permissions and group participation when determining where and how to provision resources.

The management platform 106 may implement an application-centric approach to resource management, allowing for the orchestration of complete application stacks rather than individual infrastructure components. This approach may allow users to request and manage entire applications, with the platform automatically determining and provisioning suitable computing resources 104 for the application across appropriate clouds 102, as specified by organizational policies and system configurations. The management platform 106 may maintain application context throughout the resource lifecycle, understanding relationships between application components and their supporting infrastructure. In some implementations, the management platform 106 may provide application-level monitoring, scaling, and lifecycle management capabilities. This application-centric model may abstract away infrastructure complexity, allowing users to focus on orchestrating and managing applications while the platform handles the orchestration of underlying resources and day-2 aspects. The management platform 106 may track application dependencies and requirements, using this information to make intelligent decisions about resource placement and configuration across the private cloud 102A and public clouds 102B, 102C.

The management platform 106 may provide streamlined lifecycle management of applications, from initial deployment through scaling and updates. This may include capabilities for monitoring application performance, automating scaling operations, and managing updates or patches. Users may be able to manage the entire application lifecycle through a user device 108, with the management platform 106 coordinating the requisite actions across the relevant computing resources 104 in the private cloud 102A or public clouds 102B and 102C.

The management platform 106 may integrate with various external tools and services that support the computing resources 104. These integrations may include IP address management (IPAM) systems for network address allocation, load balancers for traffic distribution, monitoring tools for performance tracking, backup systems for data protection, security scanners for vulnerability detection, domain name system (DNS) providers for name resolution, and the like. The management platform 106 may coordinate with these external tools and services during orchestration and management. For example, when configuring a computing resource 104 as part of an application’s orchestration, the management platform 106 may interact with an IPAM system to allocate an IP address, a DNS provider to register a hostname, and a load balancer to configure traffic routing. The platform may maintain associations between computing resources 104 and related external services throughout the resource lifecycle, ensuring proper cleanup and resource release when resources are decommissioned. These integrations may be configured at the organization level and may apply across resources in both the private cloud 102A and public clouds 102B, 102C.

The management platform 106 may provide capabilities for tracking and metering resource usage to enable cost management and optimization. This may involve collecting detailed usage data from the computing resources 104 across the clouds 102 and presenting it in a unified format. The platform may aggregate costs and bills from the various computing resources 104 to provide consolidated financial reporting. In some aspects, the management platform 106 may implement FinOps practices to align technology spending (on the computing resources 104) with business objectives of the organization. Users may access this data through a user device 108, gaining improved visibility into resource utilization and dependencies across the entire IT landscape. The management platform 106 may provide user interfaces for analyzing this data, helping users identify opportunities for cost optimization or efficiency improvements. In some cases, the platform may enable chargeback or showback reporting to allocate costs to specific business units or projects.

The management platform 106 may provide a comprehensive, provider-agnostic API that enables users to script and automate operations across heterogeneous cloud environments. This API may abstract away the differences between various cloud providers and on-premises systems, presenting a unified interface for managing computing resources 104 regardless of their location or underlying technology. Through this API, users can programmatically control aspects of resource provisioning, configuration, and lifecycle management across the private cloud 102A and public clouds 102B, 102C using consistent commands and data structures. In some implementations, the API may support various programming languages and offer client libraries to facilitate integration with existing tools and workflows. The provider-agnostic nature of the API may allow organizations to develop portable automation scripts and tools that can operate across different cloud environments without modification, reducing vendor lock-in and enhancing flexibility in multi-cloud strategies. These programmatic interfaces may enable advanced automation scenarios, support infrastructure-as-code practices, and facilitate integration with continuous integration and continuous delivery pipelines as well as other DevOps tools.

The management platform 106 may normalize data from heterogeneous sources into a common data model. Example sources of data may include data from computing resources 104 across the clouds 102, financial systems, management tools, and the like. This normalization may enable the management platform 106 to orchestrate workflows that span multiple environments and domains, considering the unique characteristics and capabilities of each resource type.

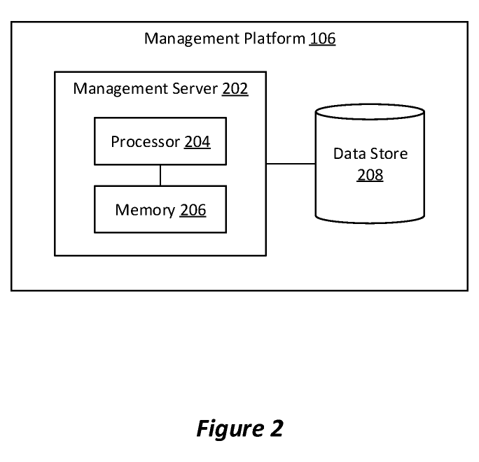

FIG. 2 is a block diagram of hardware components of the management platform 106, according to some implementations. The management platform 106 may include one or more management servers 202 and one or more data stores 208. Only one management server 202 and data store 208 are shown in this example.

In some aspects, the management server 202 may serve as a central component of the management platform 106, performing administrative functions. These functions may include managing and/or orchestrating provider-specific computing resources, normalizing heterogeneous data, processing service requests, and the like.

The management server 202 may include suitable components for performing any desired functionality. One or more modules within the server may be partially or wholly embodied as software and/or hardware for performing any functionality described herein. For example, a server may include a processor 204 and a memory 206. The processor 204 may be a microprocessor, an application-specific integrated circuit, a microcontroller, or the like. The memory 206 may be a non-transitory computer-readable medium that stores instructions for execution by the processor 204. The instructions, when executed by the processor 204, may cause the processor 204 to perform any functionality described herein.

The data store 208 may provide storage capacity for maintaining data related to the managed resources and services. In some aspects, the data store 208 may include database servers, file servers, network-attached storage (NAS) devices, or the like for storing the normalized data representing heterogeneous provider-specific computing resources. The data store 208 may be implemented using various storage technologies, such as relational databases, NoSQL data stores, distributed file systems, object storage, block storage, or the like depending on the specific requirements of the management platform 106.

In some cases, the management platform 106 may include redundant components or distributed architectures to provide high availability and fault tolerance. For example, the management server 202 may be implemented as a cluster of servers, with the workload distributed across multiple physical or virtual hosts. Likewise, the data store 208 may be implemented using a distributed database system to achieve data redundancy and availability. The management platform 106 may also incorporate load balancing mechanisms to distribute incoming requests across multiple servers.

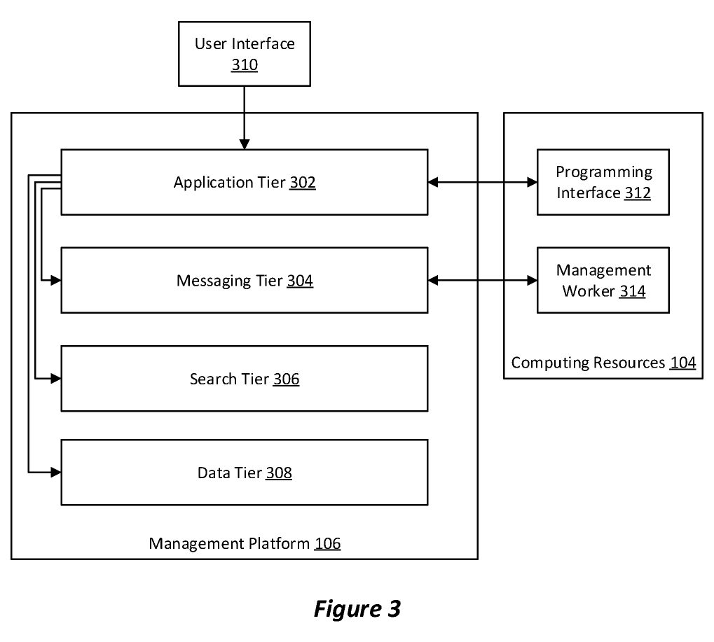

FIG. 3 is a block diagram of the software architecture of the management environment 100, according to some implementations. The diagram illustrates the various software components and tiers that make up the management platform 106 and the computing resources 104.

The management platform 106 may be implemented using a tiered architecture to organize its functionality. This architecture may include an application tier 302, a messaging tier 304, a search tier 306, and a data tier 308. The management platform 106 may include more or fewer tiers than shown in this example. The specific number and organization of tiers may vary depending on the requirements and design choices of the system.

The application tier 302 may form the core of the management platform 106, handling the primary business logic and orchestration tasks. The application tier 302 may control the other tiers within the management platform 106: the messaging tier 304, the search tier 306, and the data tier 308. In some aspects, the application tier 302 may include software applications for processing service requests, orchestrating resources, managing workflows, and the like. The application tier 302 may interact with external computing resources 104 and may coordinate activities across different cloud environments. In some implementations, the application tier 302 may be built using a microservices architecture, allowing for scalability and flexibility. The application tier 302 may leverage data stored in the data tier 308 (e.g., using a normalized data model) to make intelligent decisions about resource allocation and configuration. In some implementations, the application tier 302 may run nginx for serving a web interface, Apache Tomcat for handling business logic, and Apache Guacamole for providing remote access and control capabilities. Other applications may run in the application tier 302.

The messaging tier 304 may facilitate communication between different components of the management platform 106 and external systems. The messaging tier 304 may implement a publish-subscribe model or utilize protocols such as Advanced Message Queuing Protocol (AMQP), running a message broker like RabbitMQ, to provide reliable and asynchronous communication between various components of the management platform 106 and computing resources 104. In some aspects, the messaging tier 304 may include a load balancer that receives messages from the application tier 302 and distributes them to message brokers.

The search tier 306 may provide indexing and search capabilities for the management platform 106. This tier may enable efficient querying and retrieval of information across the normalized data model stored in the data tier 308. In some implementations, the search tier 306 may utilize a non-transactional database such as Elasticsearch to provide high-performance full-text search and analytics capabilities. The use of Elasticsearch or similar technologies may allow for rapid searching and aggregation of large volumes of data from heterogeneous sources. This search functionality may support various operations within the management platform 106, such as resource discovery, monitoring, and reporting. The search tier 306 may index data from multiple sources, including the normalized data model, logs, and metrics, to provide a unified search interface across the entire management environment.

The data tier 308 may be responsible for data storage and management within the management platform 106. This tier may implement a normalized data model that represents the heterogeneous provider-specific computing resources in a standardized format. In some aspects, the data tier 308 may utilize a transactional database (such as MySQL, PostgreSQL, or the like) to store and manage the normalized data. Using a transactional database may provide Atomicity, Consistency, Isolation, and Durability (ACID) properties, ensuring data integrity and reliability. This may be particularly important when dealing with complex relationships and dependencies between heterogeneous resources. The data tier 308 may handle database operations such as inserting, updating, and querying the normalized data, providing a consistent and reliable data layer for the other tiers of the management platform 106.

The management platform 106 may provide a user interface 310, serving as the entry point for user interactions with the system. The user interface 310 may connect directly to the application tier 302, allowing users to initiate management and orchestration tasks, view resource status, and access other platform features.

A computing resource 104 may implement various mechanisms for interacting with the management platform 106. A programming interface 312 may provide programmatic access to the platform’s functionality. The programming interface 312 may represent an API provided by a cloud provider, enabling the management platform 106 to interact with and control resources in that provider’s environment. When the management platform 106 interacts with the computing resources 104 via a programming interface 312, the application tier 302 may directly access the programming interface 312, such as via web API requests.

A management worker 314 may be executed in the computing resources 104 and may interact with the management platform 106 through messaging. The management worker 314 may be a custom application executing in the cloud provider’s environment. In some aspects, the management worker 314 may be a system process running on a computing device (e.g., a physical or virtual host). In some aspects, the management worker 314 may process tasks or messages and facilitate interactions between the management platform 106 and the specific cloud environment by sending information to the management platform 106. For example, the management platform 106 may interact with the computing resources 104 by sending messages to the management worker 314 via the messaging tier 304.

In some implementations, the management worker 314 may act as an intermediary between the management platform 106 and agents running on the computing resources 104. The management worker 314 may perform certain tasks as delegated thereto by the management platform 106. For instance, the management worker 314 may collect data from the computing resources 104 and return it to the management platform 106. The management worker 314 may also orchestrate components of the computing resources 104 based on instructions received from the management platform 106.

The management worker 314 may aggregate and multiplex communications from multiple agents running on computing resources 104 within a provider. This may potentially reduce the number of network connections to the management platform 106 from the provider. In some cases, the management worker 314 may facilitate remote host console access to the agents in the computing resources 104, act as a proxy for cloud provider APIs, and dynamically execute plugin code to perform local processing and optimization. This approach may allow organizations to manage resources across multi-cloud environments more efficiently, while maintaining security and potentially reducing network overhead.

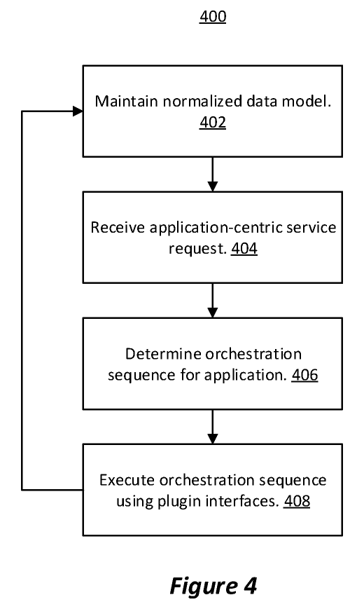

FIG. 4 is a block diagram of a management method 400, according to some implementations. The management method 400 will be described in conjunction with the management environment 100 of FIGS. 1-3. The management method 400 may be used for managing and orchestrating heterogeneous cloud resources through a normalized data model. The management method 400 may be implemented in the management environment 100. Specifically, the management platform 106 may perform the management method 400.

At step 402, the management platform 106 maintains a normalized data model of heterogeneous data from the provider-specific computing resources 104. The normalized data model may be built by obtaining heterogeneous data from various providers, which data is then normalized into the normalized data model. For example, the management platform 106 may perform data normalization in the application tier 302. In some implementations, the normalizing of the heterogeneous data is performed by the management platform 106. The normalization process transforms diverse definitions of computing resources 104 into defined schemas representing relationships and dependencies across different computing resources 104, regardless of origin. Thus, the management platform 106 has a common format for describing and managing computing resources 104 from any provider.

For example, the normalization process can include converting various configurations (of virtual machines, IP address managers, etc.) into common formats that generically represent the configurations. For example, the management platform 106 may convert VMware-specific virtual machine attributes, AWS-specific instance properties, or InfoBlox IPAM configurations into their respective common representation. In the case of resource allocation, what may be called a resource pool in VMware, a VPC in Amazon, or a resource group in Azure, can be normalized into a common representation in the data model. The normalization may preserve provider-specific features while maintaining common denominator functionality across providers. Continuing the previous example, configurations of an IP address management tool like InfoBlox can be normalized such that network resources work seamlessly with network configurations from various cloud providers without requiring custom integration code for each combination.

The normalized model maintains relationships between components while preserving provider-specific capabilities, enabling cross-service interactions through common data abstractions. The model tracks relationships between applications and supporting infrastructure, enabling services that don’t natively know about each other to interact through the normalized data model. The normalization allows the system to represent, for example, a virtual machine and a container in a common format, facilitating the management of resources across different technological paradigms through a common abstraction layer.

The normalized data model is stored in a database. For example, the management platform 106 may store the normalized data in the data tier 308. The stored model captures resource relationships, dependencies, and configurations in a format that can be efficiently queried and updated by the application tier 302. The data tier 308 may leverage a transactional database to maintain data integrity across the normalized representations. The transactional database schema includes tables that normalize infrastructure components and their relationships in the management environment. For example, a virtual machine may be represented in one table and the virtual machine’s network card may be represented in another table, with the network card’s IP address and connected switch tied off in related tables through the normalized data model. The structure tracks relationships and dependencies across heterogeneous resources while maintaining data consistency.

The data tier 308 interacts with the application tier 302 through database operations for storing and retrieving normalized data. The messaging tier 304 coordinates communication between the data tier 308 and other components through, for example, message queues, enabling asynchronous data operations. The search tier 306 may utilize a non-transactional database, such as Elasticsearch, to index the normalized data, enabling high-performance searching and aggregation across the normalized model.

The search tier 306 provides indexing and search capabilities across the normalized data model stored in the data tier 308. This enables efficient querying and retrieval of information about resources, relationships, and configurations stored in the data tier 308. The search functionality, provided by the search tier 306, supports various operations within the management platform 106, such as resource discovery, monitoring, and reporting.

The heterogeneous data may be collected by the management platform 106 through various approaches. In some cases, the application tier 302 may directly interact with the programming interface 312 of the computing resources 104 to gather data. This approach may involve making API calls to cloud provider services or on-premises systems to retrieve information about resource configurations, states, and relationships. Alternatively, the messaging tier 304 may collect data by communicating with the management worker 314 deployed within the computing resources 104.

The management worker 314 may aggregate data from multiple agents or resources within its environment and send this information to the messaging tier 304 using a messaging protocol. In some implementations, the management worker 314 may directly interact with resources that do not have a programming interface 312 usable by the application tier 302. For example, the management worker 314 may use provider-specific libraries or classes, from a provider-specific Software Development Kit (SDK), to communicate with resources and collect data, then relay that information back to the management platform 106 for normalization and storage. Additionally or alternatively, the management worker 314 may interact with the programming interface 312 (when available) of a resource. The combination of these approaches may allow the management platform 106 to gather comprehensive data about heterogeneous resources across diverse environments, even when those resources are legacy components that may not offer a programming interface usable by the management platform 106.

At step 404, a service request for application deployment is received through, for example, a user interface or programming interface. In some aspects, the management platform 106 may provide self-service capabilities, allowing end-users to request and provision applications. The application tier 302 may receive the service request through the user interface 310. The service request may specify application requirements that span multiple provider-specific computing resources. Using the normalized data model maintained at step 402, the management platform 106 can process the application deployment request based on the request’s context, such as whether the request comes from a QA department or production environment.

Thus, the management platform 106 implements an application-centric approach to resource management, allowing for the self-service orchestration of complete application stacks rather than individual infrastructure components. This approach allows end-users to request and manage entire applications, with the platform automatically determining and provisioning suitable computing resources for the application across appropriate clouds, as specified by organizational policies and system configurations. For example, a service request may request deployment of a multi-tier application. Based on the normalized data model, organization policies, and configurations, the management platform 106 may determine requisite compute resources to deploy the requested application. For example, the management platform 106 may form an orchestration plan that specifies compute resources from VMware, a network configuration via InfoBlox, and a load balancer configuration. In another example, a request may specify deploying a WordPress application, which requires the management platform 106 to identify and coordinate components, including web servers, database servers, storage, and network configurations. When deploying a web application, the request may specify requirements for a web server and a database server, where the database server is to be provisioned before the web server due to dependency requirements. The normalized data model enables the management platform 106 to deploy components in a way that makes them work together even though they don’t natively know about each other.

At step 406, the management platform 106 determines an orchestration sequence to handle the service request. The requests are processed through the normalized data model to identify the requisite resources and dependencies. The normalized model enables the management platform 106 to understand the requisite individual resources and their relationships and dependencies across different providers. Organization policies and the end-user’s request context may also influence orchestration.

The management platform 106 determines resource placement and configuration based on the application context and organizational policies. For example, the same application service request might result in different resource allocations and configurations depending on whether it’s for development, testing, or production use. This may include deploying to specific cloud providers or resource pools based on the requesting group’s role or applying different backup, monitoring, and security policies based on the deployment context. For example, when a QA team requests a testing environment, the management platform 106 may deploy resources to a lower-cost environment with different performance characteristics than a production deployment request from an operations team. The normalized data model allows contextual deployment by enabling different orchestration workflows to be seamlessly created and executed for each deployment environment or context transparently to the end-user.

The normalized data model enables the platform to maintain contextual differences using the same underlying resource definitions and relationships. In some aspects, the normalized model may transform complex orchestration processes into automated workflows. What traditionally requires multiple teams and extended timeframes can potentially be orchestrated as an automated sequence completed in minutes through the management platform 106.

At step 408, the management platform 106 executes the orchestration sequence. The orchestration may leverage the messaging tier 304 to coordinate actions across distributed resources. The normalized data model can enable the management platform 106 to sequence operations, such as allocating IP addresses before configuring network interfaces or deploying database instances before web servers. The orchestration process may include configuring day-2 operations such as backups, compliance automation, and security scan schedules.

The management platform 106 may utilize programming interfaces 312 and/or a management worker 314 within the computing resources 104 to orchestrate provider-specific computing resources in manners expected by each provider. In some implementations, a management worker 314 may receive commands from the management platform 106 through the messaging tier 304 to execute provider-specific operations. When provisioning resources, the management worker 314 may create a secure connection back to the management platform 106 and establish a command bus for coordinating actions between the platform and provider environments. The management worker 314 can operate behind load balancers for scalability and to process cloud API requests from remote locations. The management worker 314 may interact with computing resources 104 using provider-specific libraries or through the programming interface 312, allowing for flexible integration with various cloud environments and legacy systems. In some implementations, the management platform 106 may directly orchestrate resources via the programming interfaces 312 (when available) instead of using a management worker 314.

The management platform 106 utilizes a plugin architecture that generates plugin interfaces for service providers. The plugin architecture may create code templates with predefined integration points, allowing providers or end-users to implement their specific functionality while maintaining consistent interaction with the normalized data model. For example, an end-user may integrate an IPAM with the management platform 106 by creating a plugin for the IPAM. To create the plugin, the system can generate a code skeleton with defined methods that the provider fills in to allocate resources (e.g., IP addresses) or perform other specific operations. The orchestration sequence may be performed using the plugin interfaces.

The plugins are loaded at runtime through an isolated class loader, potentially within a JVM running in the application tier 302. Each plugin implements common interfaces that are clearly defined through Java documentation. The management platform 106 provides a context that allows plugins to call back into the platform and save data from computing resources 104 in the normalized format.

The database schema within the data tier 308 may support the plugin architecture by providing standardized ways to store and retrieve normalized data. When plugins interact with the management platform 106, they can store their data in the normalized format through defined interfaces, allowing the data to be used consistently across the platform regardless of the original provider format.

The plugin architecture enables runtime extension of computing resources 104 integration without modifying the core code of the management platform 106. Developers can use the generated plugin code templates when integrating new providers rather than writing custom integration code. The plugin framework handles the communication and data transformation between the provider-specific implementations (of the computing resources 104) and the normalized data model, allowing new integrations to leverage existing abstractions of the management platform 106.

The management platform 106 may orchestrate provider-specific computing resources by leveraging the normalized data model and plugin interfaces. During orchestration, the platform may invoke relevant plugins to interact with specific provider APIs or services. These plugins may translate orchestration commands from the normalized model into provider-specific API calls, allowing the management platform 106 to manage diverse resources through a unified programming interface. For example, when allocating storage, a plugin for a particular cloud provider may convert a generic storage request into the appropriate API calls for that provider’s block storage service. The plugin architecture may allow the orchestration process to seamlessly integrate new providers and resource types without modifying the core orchestration logic, enhancing the platform’s extensibility and adaptability to evolving cloud ecosystems.

The management platform 106 runs code from the plugins that interfaces with provider-specific APIs (e.g., VMware, InfoBlox, etc.) of the computing resources 104. At the same time, the normalized data model in the data tier 308 maintains the standardized representation of the operations. For example, a management worker 314 may execute provider-specific API calls to InfoBlox when allocating an IP address. Still, the results of those API calls are transformed and stored in the normalized model, enabling other components to interact with that IP address assignment without understanding InfoBlox-specific implementations.

The orchestration process can adjust its flow based on each step’s outcomes. For instance, if a call to a third-party policy API indicates additional requirements that call for extra steps in the orchestration process, the management platform 106 can inject the additional steps into the orchestration workflow. Each step in the orchestration flow has the capability of affecting subsequent steps, allowing for dynamic adaptation based on runtime conditions.

For application lifecycle management, the orchestration by the management platform 106 may include deploying various components and configuring day-2 operations. This may include deploying application code, obtaining an IP address, configuring monitoring systems, and setting up load balancer automation. When the application instance is decommissioned at the end of its lifecycle, the orchestration achieves proper cleanup, such as releasing the IP address for reuse. Throughout the application lifecycle, the process leverages the normalized data model to coordinate actions across different service providers while maintaining consistency through standardized interfaces. The management platform 106 handles both aspects of orchestration, including initial deployment and eventual teardown, providing comprehensive lifecycle management for applications across heterogeneous environments. The orchestration process through the normalized data model may transform what traditionally requires multiple teams and extended timeframes into an automated sequence of operations that may be provided in a self-service manner to end-users.

Following the orchestration operations, the normalized data model may be updated to reflect changes implemented during orchestration. In implementations, the data tier 308 performs the updating operation. For example, when an IP address is allocated during orchestration, the normalized model is updated to reflect this IP address allocation and its relationships to other resources. The updates maintain the accuracy of resource states, relationships, and configurations across the heterogeneous environment.

The search tier 306 may index the updates to enable efficient querying of the current environment. The indexing allows the management platform 106 to discover and monitor the environment, synchronizing changes to maintain an accurate inventory of infrastructure components and their dependencies. The management platform 106 can discover existing resources in the cloud and continue synchronizing any changes on a near real-time basis for provisioned resources.

The updated model can provide a foundation for subsequent orchestration operations, ensuring decisions are based on the current infrastructure state. For example, when an application instance is later modified or removed, the management platform 106 can use the updated model to understand related components that need to be reconfigured or cleaned up, such as releasing IP addresses or updating load balancer configurations. The discovery process can include monitoring installed software packages, which can be used for security scanning and compliance verification.

Maintaining, orchestrating, and updating the normalized data model establishes a continuous feedback loop where the model evolves with the infrastructure. This enables the management platform 106 to maintain consistency across heterogeneous resources while supporting complex orchestration scenarios. The normalized model allows provider-specific computing resources to interact through common interfaces while preserving their unique capabilities and requirements.

As subsequently described, the aforementioned orchestration process may include performing system-level changes to computing resources 104. One such operation is the reimaging of physical hosts with new system software, such as hypervisors or operating systems. This reimaging process may be performed to prepare the underlying infrastructure for application deployment. In some cases, the management platform 106 may coordinate the installation of system software on physical host(s) before proceeding with the deployment of application components on the system software. Thus, the management platform 106 may orchestrate an entire system stack (from bare metal to application layer) for a workload.

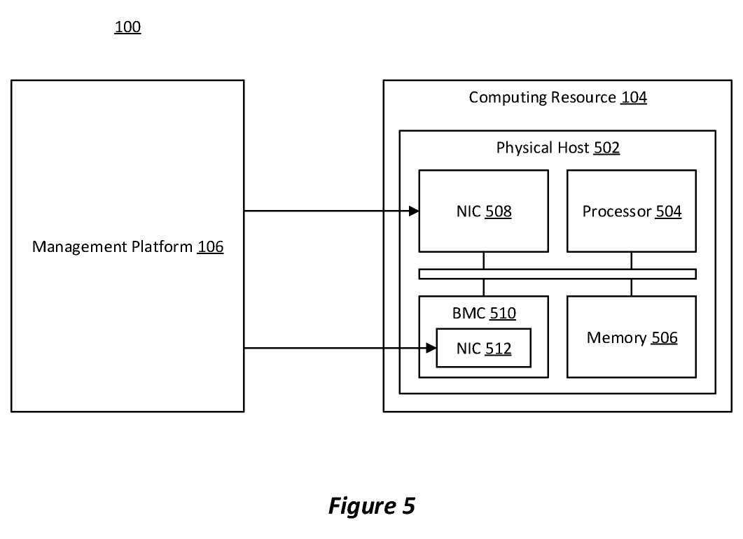

FIG. 5 is a block diagram of the cloud computing management environment 100, according to some implementations. In particular, FIG. 5 illustrates the flow of data in the reimaging process for a physical host 502 of a computing resource 104. The reimaging process, which may be orchestrated by the management platform 106, may include installing new system software on the physical host 502 and then configuring the installed system software. The management platform 106 may coordinate and control the various steps of this process, interacting with the components of the physical host 502 to facilitate the reimaging. In this example implementation, the components of the physical host 502 include a processor 504, memory 506, a network interface 508, and a baseboard management controller 510.

The processor 504 may be a central processing unit (CPU) or other processing device for executing instructions and performing computations. In some cases, the processor 504 may be a specialized processor like a graphics processing unit (GPU) or a field-programmable gate array (FPGA) for specific workloads. The processor 504 may execute the system software (e.g., operating system, hypervisor, etc.) and other software components running on the physical host 502. It may execute the software used by an application being orchestrated, which could include web servers, databases, custom application code, or the like. In some implementations, the processor 504 may support virtualization technologies, allowing it to efficiently run multiple virtual machines or containers simultaneously, each potentially hosting different components of the orchestrated application.

The memory 506 may include volatile or non-volatile storage for storing data and instructions for execution by the processor 504. In some aspects, the memory 506 may include random-access memory (RAM), read-only memory (ROM), flash memory, solid-state drives (SSDs), or other types of storage devices. The memory 506 may store the operating system, hypervisor, or other system software that controls the operation of the physical host 502. Additionally, the memory 506 may store application software, configuration files, and data used by the orchestrated application. The memory 506 may be a non-transitory computer-readable medium that stores instructions for execution by the processor 504. The instructions, when executed by the processor 504, may cause the processor 504 to perform any functionality described herein.

The network interface 508 may be a hardware component for connecting to and communicating over a network. In some aspects, the network interface 508 may be an Ethernet adapter, a Wi-Fi adapter, a Fibre Channel adapter, or another type of network interface card (NIC). The network interface 508 may support various network protocols such as Ethernet, InfiniBand, or the like. It may be used by the orchestrated application for network communication, allowing the application to send and receive data over a network. For example, if the orchestrated application is a database server, the network interface 508 may handle incoming client connections and outgoing data transfers. After system software is installed on the physical host 502, the management platform 106 may orchestrate the application on the system software via the network interface 508 by sending configuration commands, deploying application components, and monitoring network traffic. The management platform 106 may use the network interface 508 to establish secure connections for remote management, transfer application binaries and data, and collect performance metrics from the orchestrated application running on the physical host 502.

The baseboard management controller 510 may be a specialized controller integrated with other components of the physical host 502. In some cases, the baseboard management controller 510 may operate independently of the processor 504 and the system software of the physical host 502. The baseboard management controller 510 may provide out-of-band management and monitoring capabilities for the physical host 502. The baseboard management controller 510 may include its own hardware (processor, memory, etc.) and firmware.

The baseboard management controller 510 may monitor various aspects of the physical host 502, such as temperature, power usage, fan speeds, and system events. In some cases, the baseboard management controller 510 may collect detailed telemetry data on hardware performance and health, which can be used for predictive maintenance and capacity planning. The baseboard management controller 510 may also provide alerts and notifications when certain thresholds are exceeded, enabling proactive management of the physical host 502.

The baseboard management controller 510 may provide remote management capabilities, allowing administrators to control the physical host 502 even when the main system software is not functioning. In some aspects, the baseboard management controller 510 may be configured to modify settings of the physical host 502 (e.g., BIOS or EFI settings), such as changing the boot order of the physical host 502.

The baseboard management controller 510 may power on, power off, or reboot the physical host 502. In some implementations, the baseboard management controller 510 may support scheduled power operations, allowing administrators to automate system maintenance tasks. The baseboard management controller 510 may also provide power capping capabilities, enabling organizations to manage energy consumption across their data centers more effectively.

The baseboard management controller 510 may mount media, such as a virtual disk, to the physical host 502, for example by emulating a drive on a host bus adapter (HBA). This capability may allow administrators to remotely install operating systems or hypervisors by mounting installation media. The virtual media functionality may also be used for applying software updates or running diagnostic tools without physical access to the server.

The baseboard management controller 510 may include a management network interface 512, which may enable remote management of the physical host 502. In some cases, the management network interface 512 may be a dedicated network interface separate from the main network interface 508 of the physical host 502. This separation may allow for out-of-band management, meaning the baseboard management controller 510 may be accessed even when the main system is powered off or unresponsive. The management platform 106 may communicate with the physical host 502 through both the network interface 508 for regular network traffic and through the management network interface 512 of the baseboard management controller 510 for certain management operations, including those related to the reimaging process.

The baseboard management controller 510 may support various management protocols and interfaces. The baseboard management controller 510 may support management protocols such as Intelligent Platform Management Interface (IPMI), Redfish, or the like. These protocols may provide remote power control, hardware monitoring, firmware updates, and other out-of-band management functions. In some cases, the baseboard management controller 510 may use a Representational State Transfer (REST) application programming interface (API) for communication. The REST API may provide a standardized way for the management platform 106 to interact with the baseboard management controller 510, enabling efficient and flexible remote management capabilities. The baseboard management controller 510 may also provide a web-based interface for direct user interaction, offering a graphical interface for monitoring and managing the physical host 502.

The management platform 106 may leverage the capabilities of the baseboard management controller 510 to facilitate the reimaging process for the physical host 502. In some cases, the reimaging process may begin with the management platform 106 streaming an installation media to the management network interface 512 of the baseboard management controller 510. The installation media may be in any desired file system format. For example, it may be in a standard format for optical disc media, such as ISO 9660 format.

The baseboard management controller 510 may use the streamed installation media to perform the reimaging process on the physical host 502. In some aspects, the baseboard management controller 510 may mount the installation media as a virtual drive, allowing the physical host 502 to boot from the virtual media. This may enable the management platform 106 to remotely initiate and control the reimaging process without physical access to the physical host 502. The baseboard management controller 510 may also reboot the physical host 502 and potentially change the boot order to boot from the mounted virtual media

In some cases, the reimaging process may occur without manual intervention, allowing for automated installation of the new system software. An unattended installation process may be performed upon rebooting the physical host 502 from the virtual media. This may involve pre-configuring parameters such as disk partitioning, network settings, and initial user accounts for the installer. In some implementations, the management platform 106 may embed an unattended install file in the streamed media so that an unattended install occurs on the physical host 502 upon reboot. This unattended install file may contain configuration information and responses to installation prompts, enabling the installation process to proceed automatically without user input. The unattended install file may be generated from normalized data of the management platform 106 (previously described), from a configuration received from a user (subsequently described), or the like. By leveraging unattended installation capabilities, the management platform 106 may streamline the reimaging process for the physical host 502.

After the initial installation of the new system software (via the management network interface 512 of the baseboard management controller 510), the management platform 106 may complete the configuration process by communicating through the network interface 508 of the physical host 502. This may involve tasks such as configuring network and security settings, installing additional software packages, or applying system updates. In some aspects, this may include setting up specific components needed for orchestrated applications, such as configuring application servers, databases, or other middleware.

Throughout the reimaging process, the management platform 106 may interact with the baseboard management controller 510. In some cases, the management platform 106 may use the REST API of the baseboard management controller 510 to initiate and/or monitor the progress of the reimaging process, retrieve system status information, or send additional commands as needed.

Utilizing the baseboard management controller 510 for the reimaging process may provide several advantages. The out-of-band management capabilities may allow the management platform 106 to reimage the physical host 502 even if the current system software is non-functional or inaccessible. The ability to stream installation media directly to the baseboard management controller 510 may eliminate the need for physical media or local access to the physical host 502, potentially enabling remote and automated reimaging of multiple physical hosts 502 simultaneously.

A reimaging process may also be utilized in other contexts. As subsequently described, a reimaging process may be utilized to facilitate the initial setup and configuration of multiple physical hosts 502 when establishing a new infrastructure, such as when initially setting up a private cloud 102A (see FIG. 1). This process may be performed during the initial deployment of computing resources 104, such as newly acquired bare metal servers, that are to be configured with a specific hypervisor. The reimaging process can be performed even before a management platform 106 has been established, leveraging the capabilities of the baseboard management controllers 510 within the physical hosts 502 to efficiently coordinate and execute the installation of new hypervisors across multiple physical hosts.

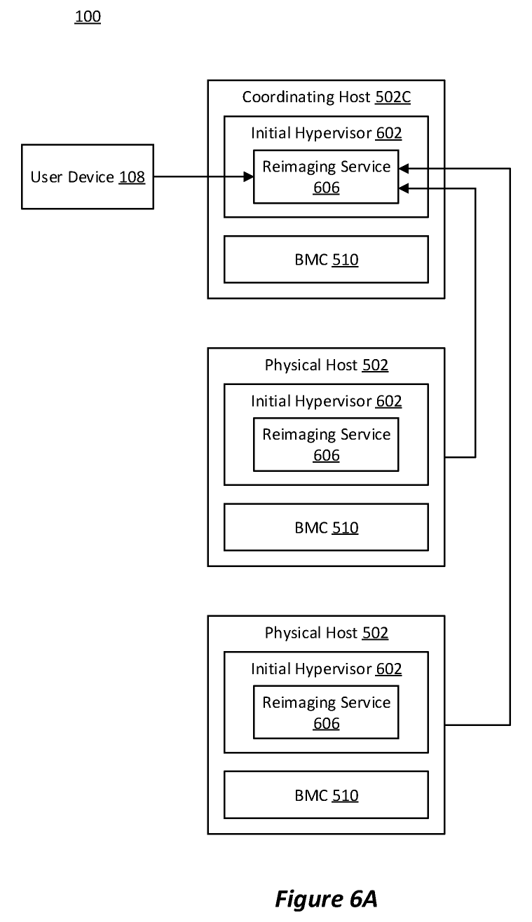

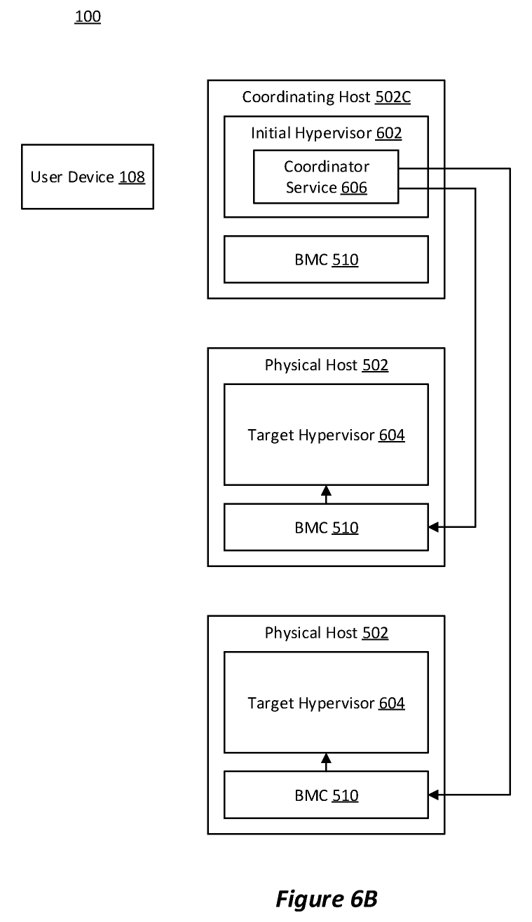

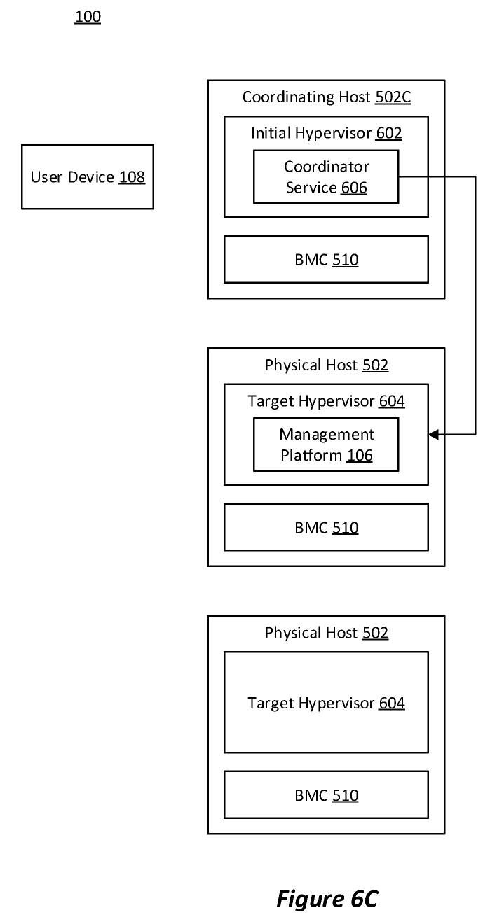

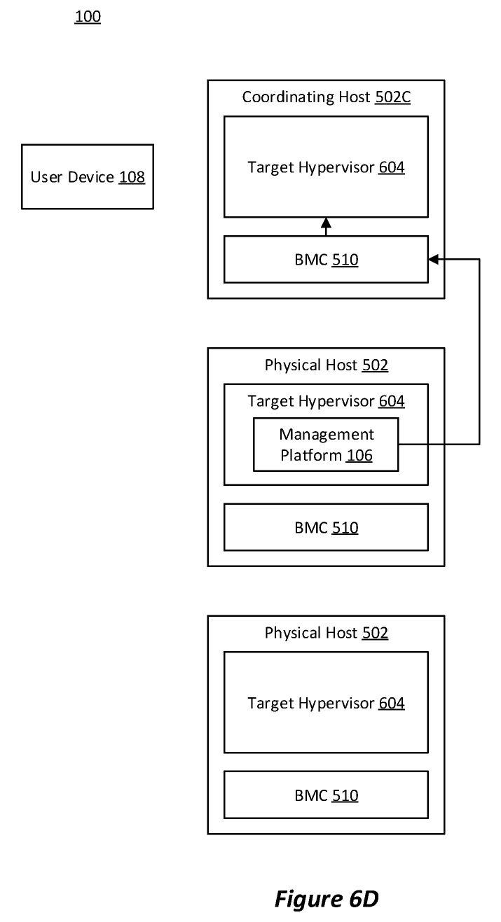

FIGS. 6A-6D are block diagrams of intermediate steps in a reimaging process for a plurality of physical hosts 502, according to some implementations. At the start of the reimaging process, the physical hosts 502 may be running an initial hypervisor 602 (or other system software), which may be pre-installed when the hosts are procured. The reimaging process may be initiated in response to a service request from a user device 108, with the goal of transitioning the physical hosts 502 from the initial hypervisor 602 to a target hypervisor 604 (or other system software). This allows organizations to quickly adapt new hardware to their preferred hypervisor technology, setting the foundation for their initial IT environment. In some aspects, the user device 108 and physical hosts 502 may be connected together on a same network.

In FIG. 6A, one of the physical hosts 502 is designated as a coordinating host 502C. Each of the physical hosts 502 may include a baseboard management controller 510 and be running an initial hypervisor 602. The coordinating host 502C is primus inter pares in relation to the other physical hosts 502 for part of the reimaging process, as the coordinating host 502C may take on a leadership role in orchestrating hypervisor reimaging, but may otherwise have a similar configuration as the other physical hosts 502.

Each of the physical hosts 502 may include a reimaging service 606 running on the initial hypervisor 602. The reimaging service 606 of the coordinating host 502C may interact with the user device 108 to perform the reimaging process of the other physical hosts 502. The reimaging services 606 of the other physical hosts 502 may aid the coordinating host 502C with host discovery during reimaging.

The process of designating the coordinating host 502C may involve multiple steps. In some cases, each physical host 502 may advertise the same domain name via their reimaging service 606. When the user device 108 navigates to that domain name, the physical host 502 that last advertised the domain name may respond to the user device 108 and thus may be designated as the coordinating host 502C. In some implementations, a local DNS server may be involved in this process. The local DNS server may receive the domain name advertisements from the physical hosts 502 and may cache the IP addresses associated with the domain name. When the user device 108 queries the local DNS server for the domain name, the server may return the most recently cached IP address, which may correspond to the physical host 502 that advertised last.

The coordinating host 502C may discover target hosts 502 for reimaging using various methods. In some aspects, the coordinating host 502C may use IPv6 broadcasting to discover available target hosts 502 for reimaging. The reimaging service 606 of each physical host 502 may broadcast information about its baseboard management controller 510 over IPv6. The broadcast information may include the MAC address of the baseboard management controller 510. The coordinating host 502C may receive these broadcasts and use them to identify potential target hosts 502 for reimaging. In some implementations, the coordinating host 502C may determine the IPv6 address of a target host’s baseboard management controller 510 based on its MAC address. This is possible because a IPv6 link-local address is generated based on the MAC address of the network interface.

After discovering the available target hosts 502, the coordinating host 502C may present a list of discovered hosts to the user device 108, such as via a user interface displayed to the user device 108. The user may then select which of the discovered hosts should be reimaged. This select may be received as part of a service request (subsequently described).

In some cases, the coordinating host 502C may collect baseboard configurations from the target hosts 502. This information may be collected from the baseboard management controllers 510 of the target hosts 502 or from services running on the physical hosts 502. In some implementations, a reimaging service 606 may obtain the baseboard configuration from the baseboard management controller 510 of its physical host 502 using a device driver and send the configuration to the coordinating host 502C (using the host’s network interface). In some implementations, a baseboard management controller 510 may directly send its own baseboard configuration to the coordinating host 502C (using the BMC’s network interface). The baseboard configurations collected by the coordinating host 502C may include details such as IP addresses, usernames, passwords, and other BMC-related information for the target hosts 502. The coordinating host 502C may subsequently use these baseboard configurations to control the baseboard management controllers 510 of the target hosts 502 during the installation process of the target hypervisor 604.

In some cases, the coordinating host 502C may obtain a host configuration for each target host 502 by communicating with the baseboard management controller 510 of each target host 502 using a Representational State Transfer (REST) application programming interface (API). The coordinating host 502C may modify the host configuration of a target host 502 before streaming the installation media to that target host 502. A host configuration may include BIOS/EFI settings (e.g., boot order), network settings, and other configuration parameters of the target hosts 502. The coordinating host 502C may modify the host configuration of a target host 502 before streaming the installation media to the target host 502. For example, the coordinating host 502C may change the boot order so that the target host 502 boots from the streamed installation media. The host configuration may be used to customize the installation process for each target host 502, allowing different settings to be applied to each host as needed during the reimaging process.

The reimaging service 606 on the coordinating host 502C may receive a service request from the user device 108. This service request may specify target hosts 502 to be reimaged from the initial hypervisor 602 to a target hypervisor 604. In some aspects, the service request may include respective reimaging configurations for each of the target hosts 502. The reimaging configurations may include details such as hostnames, network configurations (e.g. IP addresses, netmasks, DNS settings), initial usernames, and initial passwords for the target hosts 502, each of which may be specified by the user device 108 in the service request. The user device 108 may submit this service request to the coordinating host 502C, for example through a web interface provided by the reimaging service 606 running on the coordinating host 502C.

The coordinating host 502C may display a plurality of available hypervisors for the physical hosts 502 to the user device 108. The coordinating host 502C may solicit a selection of the target hypervisor 604 from the user device 108, which selection may be included as part of the service request. The coordinating host 502C may then obtain an installation media for the target hypervisor 604. In some implementations, the coordinating host 502C may request the installation media from the user device 108, which may then upload it to the coordinating host 502C.

In FIG. 6B, the coordinating host 502C installs the target hypervisor 604 on each of the target hosts 502 except itself (if the coordinating host 502C has been chosen by the user device 108 as a target host). The coordinating host 502C may install the target hypervisor 604 on each of the target hosts 502 through a streaming process. In the streaming process, an installation media for the target hypervisor 604 may be streamed from the coordinating host 502C to each of the target hosts 502. This streaming approach may allow for efficient distribution of the installation media across multiple target hosts simultaneously.

To avoid manual interaction during reimaging, an unattended installation process may be performed for the target hypervisor 604. To facilitate an unattended installation process, the coordinating host 502C may generate and embed a respective reimaging configuration for each target host 502 within the installation media as it is streamed to the hosts. In some implementations, this reimaging configuration is an unattended installation file, which may be generated by the coordinating host 502C based on specific parameters for each target host 502 (e.g., in the service request previously received from the user device 108).

The process of generating the unattended installation files may involve several steps. First, the coordinating host 502C may parse the reimaging configurations received in the service request. It may then create or obtain a template unattended installation file based on the requirements of the target hypervisor 604. For each target host 502, the coordinating host 502C may populate this template with the specific details from the host’s reimaging configuration, such as hostname, network settings, and initial credentials. The coordinating host 502C may also include any necessary commands or scripts to automate post-installation tasks, such as joining a domain or installing additional software packages.

The embedding process may involve modifying the file system of the installation media in real-time during streaming to a target host 502. As the media is streamed, the coordinating host 502C may identify the media’s file system structure, locate the appropriate directory for unattended installation files, inject the generated unattended installation file, update any metadata or index files if needed, and stream the modified chunks of the media to the target host 502. This approach allows for customization of the installation media for each target host 502 without creating multiple copies, enabling host-specific settings to be applied during unattended installation.

When the installation media (potentially with an embedded configuration) is streamed to a target host 502, the coordinating host 502C may reboot the target host 502. Upon reboot, the target host 502 may boot from the streamed installation media and automatically begin an unattended installation process using the embedded configuration, allowing for a hands-off transition to the target hypervisor 604. In some cases, this may also involve changing the boot order of the target host 502 so that it boots from the streamed installation media upon reboot.

The streaming and installation process may be implemented through the baseboard management controllers 510 of the physical hosts 502. In this approach, the coordinating host 502C may stream the installation media to the baseboard management controller 510 of each target host 502. A baseboard management controller 510 may mount the streamed media as a virtual media device within its physical host 502, making the media visible to the host as a virtual disk. In some aspects, the coordinating host 502C may expose a respective media endpoint for each baseboard management controller 510 to access its version of the installation media. The coordinating host 502C may then send instructions to the baseboard management controller 510 of each target host 502, directing it to access the installation media at its designated endpoint. This approach may allow for controlled and individualized access to the installation media for each target host 502. Additionally, a baseboard management controller 510 may be instructed to modify the configuration of its target host 502, such as changing the boot order, and initiate a reboot of the target host 502. Thus, the out-of-band management capabilities of the baseboard management controller 510 are leveraged to facilitate the unattended installation process for the target hypervisor 604. In some implementations, these instructions may be sent to the baseboard management controllers 510 over the network using a previously described management protocol such as IPMI, Redfish, or the like.

Throughout the reimaging process, the coordinating host 502C may implement error handling and recovery procedures. Status updates may be provided to the user device 108 through a user interface, including any errors encountered and remediation steps taken. If an error occurs during the reimaging of a target host 502, the coordinating host 502C may attempt to resolve the issue automatically or, if unable to do so, may notify the user device 108 and await further instructions.

In FIG. 6C, the management platform 106 (previously described for FIGS. 1-4) is deployed to one of the reimaged target hosts 502. The coordinating host 502C may configure the management platform 106 in the target hypervisor 604 of one of the target hosts 502. The management platform 106 may include a service (e.g., a management and orchestration service) which will take over the reimaging process for the coordinating host 502C in a subsequent step. Specifically, the management platform 106 may reimage the coordinating host 502C in a similar manner as the other target hosts 502 were reimaged. This handover process may allow all of the desired hosts, including the initial coordinating host 502C, to be transitioned to the target hypervisor 604.

The coordinating host 502C may select one of the target hosts 502 to run the management platform 106 based on predetermined criteria. The criteria may include available resources such as CPU, memory, or storage capacity of each target host 502. The criteria may include the hosts’ network connectivity and proximity to other resources. In some implementations, the coordinating host 502C may select the first available target host 502 or the first target host 502 that was successfully upgraded to the target hypervisor 604. Control of the reimaging process will be handed over to the target host 502.

In some cases, the management platform 106 may be retrieved from a cloud-based software catalog. A cloud-based software catalog may be a repository of software that is on a different network than the physical hosts 502. The coordinating host 502C may retrieve a binary for the management platform 106 from the cloud-based software catalog and deploy the binary on one of the target hosts 502. This process may involve authenticating with the cloud-based software catalog, selecting the appropriate version of the management platform 106, and securely downloading the binary. Alternatively, the coordinating host 502C may retrieve a virtual machine (such as a virtual appliance) for the management platform 106 from the cloud-based software catalog and deploy the virtual machine on the target hypervisor 604 of the selected target host 502. The coordinating host 502C may verify the integrity of the downloaded components (binary or virtual machine) using checksums or digital signatures before deployment. The coordinating host 502C may also configure network settings and storage allocation for the deployed virtual machine.

After configuring the management platform 106, the coordinating host 502C may transmit credentials of the coordinating host 502C to the management platform 106. The credentials of the coordinating host 502C may be credentials of the baseboard management controller 510 of the coordinating host 502C, which the management platform 106 may subsequently use to authenticate with the baseboard management controller 510 of the coordinating host 502C when streaming an install media to the coordinating host 502C. This credential transmission may be performed using a secure communication channel to prevent unauthorized access. The transmission of credentials may also include additional metadata such as the host configuration, baseboard configuration, or other information of the coordinating host 502C that may be used by the management platform 106 to reimage the coordinating host 502C.

The coordinating host 502C may forward the installation media for the target hypervisor 604 to the management platform 106. Before this transfer occurs, a security handshake may be performed. The management platform 106 may validate the credentials of the coordinating host 502C by authenticating directly with the baseboard management controller 510 of the coordinating host 502C. This validation process helps ensure the coordinating host 502C is authorized to provide the installation media and prevents unauthorized file uploads to the management platform 106. Once the credentials are validated, the forwarding process may begin. This may involve creating a copy of the installation media or providing access to a shared storage location where the installation media is stored. The coordinating host 502C may use various data transfer protocols to transmit the installation media to the management platform 106. After receiving the installation media, the management platform 106 may verify its integrity and authenticity using cryptographic hash functions or digital signatures. Additionally, the coordinating host 502C may provide metadata about the installation media, such as version information, build number, or specific configuration details that may be relevant for the reimaging process.

After the coordinating host 502C configures the management platform 106 and hands off information to it, the user device 108 may be redirected from the coordinating host 502C to the management platform 106. This redirection may be implemented through various methods, such as HTTP redirects, DNS updates, or by providing a new URL to the user device 108. The redirection process may include a handshake mechanism to confirm the management platform 106 is fully operational before redirecting the user device 108. Additionally, the user device 108 may be provided with new authentication tokens or session information for the management platform 106 to maintain a seamless user experience after the redirection.

In FIG. 6D,the target hypervisor 604 is installed on the coordinating host 502C by the management platform 106. The management platform 106 may install the target hypervisor 604 on the coordinating host 502C by streaming the installation media from the management and orchestration service to the coordinating host 502C. The target hypervisor 604 may be installed on the coordinating host 502C as previously described for FIG. 5, and in an analogous manner as to how the target hypervisor 604 was installed on the target hosts 502C as previously described for FIG. 6B. The installation process may involve the baseboard management controller 510 of the coordinating host 502C accessing a media endpoint for the install media at the management platform 106. The installation media may be mounted as a virtual media device in the coordinating host 502C, and the coordinating host 502C may be rebooted to initiate an unattended installation process.

Optionally, additional steps may be subsequently performed. For example, after its initial setup, the management platform 106 may be moved between physical hosts 502 using live virtual machine migration technologies. This movement may occur because the reimaged physical hosts 502 form a cluster running the target hypervisor 604, and the management platform 106 may be part of a virtual machine running in the cluster. The cluster configuration enables the management platform 106 to be dynamically relocated to different physical hosts 502 within the cluster without interruption to its operations.

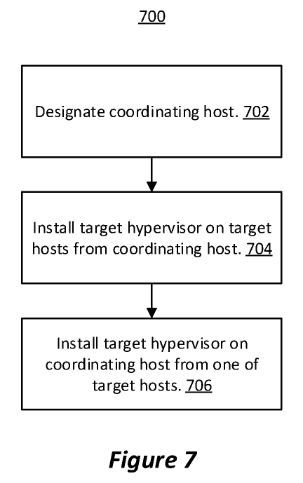

FIG. 7 illustrates a flowchart of a host reimaging method 700, according to some implementations. The host reimaging method 700 will be described in conjunction with FIGS. 6A-6D. The host reimaging method 700 may be performed within the management environment 100 as part of the reimaging process.

In step 702, a coordinating host 502C may be designated from a plurality of physical hosts 502. As previously described for FIG. 6A, each of the physical hosts 502 may include a baseboard management controller 510 and may be running an initial hypervisor 602. The designation process may involve each physical host 502 broadcasting a setup domain name. The coordinating host 502C may be designated when a user device 108 accesses this setup domain name at the coordinating host 502C.

In step 704, a target hypervisor 604 may be installed on target hosts 502. As previously described for FIG. 6B, this may begin with the coordinating host 502C receiving (from the user device 108) a service request to reimage the target hosts 502 from the initial hypervisor 602 to the target hypervisor 604. In response to this request, the coordinating host 502C may obtain an installation media for the target hypervisor 604 (also potentially from the user device 108). The coordinating host 502C may then install the target hypervisor 604 on each target host 502 by streaming the installation media to the baseboard management controller 510 of each target host 502, potentially embedding a unique reimaging configuration (such as an unattended file) in the version of the installation media streamed to each target host 502.

In step 706, the installation of the target hypervisor 604 on the coordinating host 502C may be handed off. As previously described for FIGS. 6C and 6D, this may involve the coordinating host 502C configuring a management platform 106 in one of the target hosts 502. The management platform 106 may include a management and orchestration service. The target hypervisor 604 may then be installed on the coordinating host 502C by streaming the installation media from the management platform 106 to the coordinating host 502C.

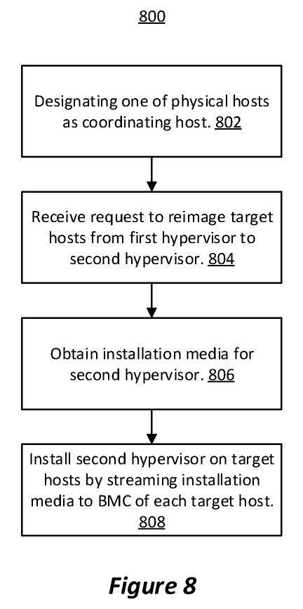

FIG. 8 illustrates a flowchart of a host reimaging method 800, according to some implementations. The host reimaging method 800 will be described in conjunction with FIGS. 6A-6D. The host reimaging method 800 may be performed within the management environment 100.

The coordinating host 502C may perform a step 802 of designating one of a plurality of physical hosts 502 as the coordinating host 502C. In some cases, each of the physical hosts 502 may include a baseboard management controller 510 and a first hypervisor.

The coordinating host 502C may perform a step 804 of receiving a service request to reimage target hosts 502 of the physical hosts 502 from the first hypervisor to a second hypervisor. In some cases, the second hypervisor may be different than the first hypervisor.

The coordinating host 502C may perform a step 806 of obtaining an installation media for the second hypervisor in response to the service request. In some cases, the coordinating host 502C may display a plurality of available hypervisors to the user device 108. The coordinating host 502C may solicit a selection of the second hypervisor from the user device 108. The coordinating host 502C may request the installation media for the second hypervisor from the user device 108.

The coordinating host 502C may perform a step 808 of installing the second hypervisor on each of the target hosts 502 by streaming the installation media from the coordinating host 502C to the baseboard management controller 510 of each of the target hosts 502. In some cases, the coordinating host 502C may discover the target hosts 502 (before step 804) by receiving a baseboard configuration for the baseboard management controller 510 of each of the target hosts 502. The coordinating host 502C may stream the installation media based on the baseboard configuration of each of the target hosts 502.

In some cases, the baseboard configuration of each of the target hosts 502 may be received from a reimaging service 606 executing on each of the target hosts 502. In other cases, the baseboard configuration of each of the target hosts 502 may be received from the baseboard management controller 510 of each of the target hosts 502.

The coordinating host 502C may obtain a host configuration for each of the target hosts 502 by communicating with the baseboard management controller 510 of each of the target hosts 502 using a management protocol. In some cases, the management protocol may include a Representational State Transfer (REST) application programming interface (API) of the baseboard management controller 510. The coordinating host 502C may modify the host configuration of one of the target hosts 502 before streaming the installation media (such as to specify boot order).

In some cases, streaming the installation media may include exposing, by the coordinating host 502C, a media endpoint for accessing the installation media. The coordinating host 502C may send, to the baseboard management controller 510 of each of the target hosts 502, instructions to access the installation media at the media endpoint.

Installing the second hypervisor may further include instructing, by the coordinating host 502C, the baseboard management controller 510 of each respective target host 502 of the target hosts 502 to mount the installation media as a virtual media device in the respective target host 502. The coordinating host 502C may instruct the baseboard management controller 510 of each respective target host 502 to reboot the respective target host 502.

In some cases, the coordinating host 502C may discover the target hosts 502 using IPv6 broadcasting. The baseboard management controller 510 of each physical host 502 may broadcast its own configuration information instead of a process running on the physical host 502 broadcasting that information.

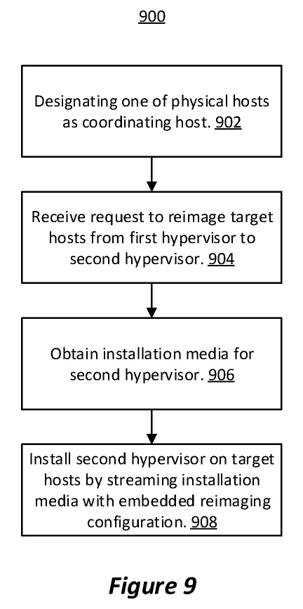

FIG. 9 illustrates a flowchart of a host reimaging method 900, according to some implementations. The host reimaging method 900 will be described in conjunction with FIGS. 6A-6D. The host reimaging method 900 may be performed within the management environment 100.

The coordinating host 502C may perform a step 902 of designating one of a plurality of physical hosts 502 as the coordinating host 502C. In some cases, each of the physical hosts 502 may include a baseboard management controller 510 and a first hypervisor.

The coordinating host 502C may perform a step 904 of receiving a service request to reimage target hosts 502 of the physical hosts 502 from the first hypervisor to a second hypervisor. In some cases, the second hypervisor may be different than the first hypervisor. The service request may include a respective reimaging configuration for each respective target host 502.

The coordinating host 502C may perform a step 906 of obtaining an installation media for the second hypervisor in response to the service request. In some cases, the coordinating host 502C may display a plurality of available hypervisors to the user device 108. The coordinating host 502C may solicit a selection of the second hypervisor from the user device 108. The coordinating host 502C may request the installation media for the second hypervisor from the user device 108.

The coordinating host 502C may perform a step 908 of installing the second hypervisor on each of the target hosts 502 by streaming the installation media from the coordinating host 502C to each of the target hosts 502. In some cases, streaming the installation media may include embedding the respective reimaging configuration for each target host 502 in the installation media streamed to that target host 502.

In some cases, embedding the respective reimaging configuration may involve modifying a file system of the installation media in real-time while streaming the installation media. The installation media may use ISO 9660 file system format.

The reimaging configuration for each target host 502 may include a hostname, a network configuration, an initial username, and an initial password. In some cases, the network configuration may include an IP address, a netmask, and DNS settings of the respective target host 502.

In some cases, embedding the respective reimaging configuration may involve injecting a respective unattended installation file into the installation media for each target host 502. The coordinating host 502C may generate the respective unattended installation file for each target host 502 based on the respective reimaging configuration.

The coordinating host 502C may expose a respective media endpoint for each target host 502 to access the installation media. In some cases, the coordinating host 502C may send instructions to the baseboard management controller 510 of each target host 502 to access the respective installation media at the respective media endpoint.

In some cases, the coordinating host 502C may instruct the baseboard management controller 510 of each target host 502 to mount the installation media as a virtual media device in the respective target host 502. The coordinating host 502C may instruct the baseboard management controller 510 of each target host 502 to reboot the respective target host 502.

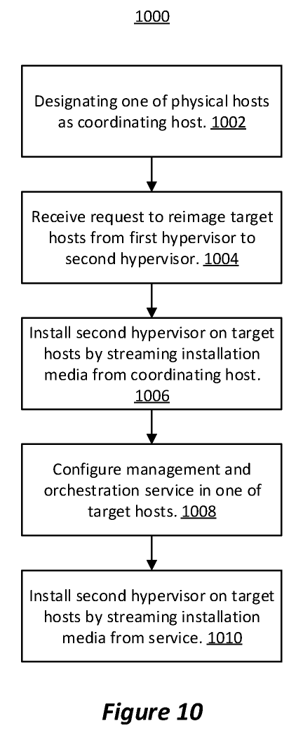

FIG. 10 illustrates a flowchart of a host reimaging method 1000, according to some implementations. The host reimaging method 1000 will be described in conjunction with FIGS. 6A-6D. The host reimaging method 1000 may be performed within the management environment 100.

The coordinating host 502C may perform a step 1002 of designating one of a plurality of physical hosts 502 as the coordinating host 502C. In some cases, each of the physical hosts 502 may include a first hypervisor.

The coordinating host 502C may perform a step 1004 of receiving a service request to reimage target hosts 502 of the physical hosts 502 from the first hypervisor to a second hypervisor. In some cases, the second hypervisor may be different than the first hypervisor. The service request may be received from the user device 108.

The coordinating host 502C may perform a step 1006 of installing the second hypervisor on each of the target hosts 502 by streaming an installation media for the second hypervisor from the coordinating host 502C to each of the target hosts 502.

The coordinating host 502C may perform a step 1008 of configuring a management and orchestration service (e.g., part of the management platform 106) in one of the target hosts 502 from the coordinating host 502C. In some cases, the coordinating host 502C may select one of the target hosts 502 to run the management and orchestration service based on predetermined criteria. In some cases, the coordinating host 502C may retrieve a binary for the management and orchestration service from a cloud-based software catalog. The coordinating host 502C may deploy the binary on one of the target hosts 502. In some cases, the coordinating host 502C may retrieve a virtual machine for the management and orchestration service from a cloud-based software catalog. The coordinating host 502C may deploy the virtual machine on the second hypervisor of one of the target hosts 502. In some cases, the coordinating host 502C may redirect the user device 108 to the management and orchestration service after configuring the management and orchestration service.

The management platform 106 may perform a step 1010 of installing the second hypervisor on the coordinating host 502C by streaming the installation media from the management and orchestration service to the coordinating host 502C, such as to its baseboard management controller 510. In some cases, the coordinating host 502C may access a media endpoint for the installation media at the management and orchestration service. The coordinating host 502C may mount the installation media as a virtual media device. The coordinating host 502C may reboot as part of installing the second hypervisor.

In some cases, after configuring the management and orchestration service, the coordinating host 502C may transmit credentials of the coordinating host 502C to the management and orchestration service. The credentials of the coordinating host 502C may be credentials of the baseboard management controller 510 of the coordinating host 502C. In some cases, the coordinating host 502C may forward the installation media for the second hypervisor to the management and orchestration service.

In some cases, the management and orchestration service may validate the credentials of the coordinating host 502C before installing the second hypervisor on the coordinating host 502C. The management and orchestration service may perform a security handshake with the coordinating host 502C before accepting the installation media.

Although this disclosure describes or illustrates particular operations as occurring in a particular order, this disclosure contemplates the operations occurring in any suitable order. Moreover, this disclosure contemplates any suitable operations being repeated one or more times in any suitable order. Although this disclosure describes or illustrates particular operations as occurring in sequence, this disclosure contemplates any suitable operations occurring at substantially the same time, where appropriate. Any suitable operation or sequence of operations described or illustrated herein may be interrupted, suspended, or otherwise controlled by another process, such as an operating system or kernel, where appropriate. The acts can operate in an operating system environment or as stand-alone routines occupying all or a substantial part of the system processing.

While this disclosure has been described with reference to illustrative implementations, this description is not intended to be construed in a limiting sense. Various modifications and combinations of the illustrative implementations, as well as other implementations of the disclosure, will be apparent to persons skilled in the art upon reference to the description. It is therefore intended that the appended claims encompass any such modifications or implementations.

What is claimed is:

1. A computer-implemented method comprising:
designating one of a plurality of physical hosts as a coordinating host, wherein each of the physical hosts comprises a first hypervisor;
receiving, by the coordinating host, a service request to reimage target hosts of the physical hosts from the first hypervisor to a second hypervisor, the second hypervisor being different than the first hypervisor;
installing the second hypervisor on each of the target hosts by streaming an installation media for the second hypervisor from the coordinating host to each of the target hosts;
configuring, by the coordinating host, a management and orchestration service in one of the target hosts from the coordinating host; and
installing the second hypervisor on the coordinating host by streaming the installation media from the management and orchestration service to the coordinating host.

2. The method of claim 1, wherein configuring the management and orchestration service comprises:
retrieving, by the coordinating host, a binary for the management and orchestration service from a cloud-based software catalog; and
deploying the binary on one of the target hosts.

3. The method of claim 1, wherein configuring the management and orchestration service comprises:
retrieving, by the coordinating host, a virtual machine for the management and orchestration service from a cloud-based software catalog; and
deploying the virtual machine on the second hypervisor of one of the target hosts.

4. The method of claim 1, further comprising, after configuring the management and orchestration service:
transmitting, by the coordinating host, credentials of the coordinating host to the management and orchestration service.

5. The method of claim 4, further comprising:
validating, by the management and orchestration service, the credentials of the coordinating host prior to installing the second hypervisor on the coordinating host.

6. The method of claim 5, wherein each of the physical hosts further comprises a baseboard management controller, the installation media is streamed to the baseboard management controller of each of the target hosts and the coordinating host, and the credentials of the coordinating host are credentials of the baseboard management controller of the coordinating host.

7. The method of claim 1, wherein the service request is received from a user device, and the method further comprises:
redirecting the user device from the coordinating host to the management and orchestration service after configuring the management and orchestration service.

8. The method of claim 1, further comprising:
receiving, by the coordinating host, the installation media for the second hypervisor from a user device; and
forwarding the installation media for the second hypervisor from the coordinating host to the management and orchestration service.

9. The method of claim 1, wherein installing the second hypervisor on the coordinating host further comprises:
accessing a media endpoint for the installation media at the management and orchestration service;
mounting the installation media as a virtual media device in the coordinating host; and
rebooting the coordinating host.

10. A computer system comprising:
a plurality of physical hosts, each physical host comprising a first hypervisor, wherein a coordinating host designated from the physical hosts is configured to:
receive a service request to reimage target hosts of the physical hosts from the first hypervisor to a second hypervisor, the second hypervisor being different than the first hypervisor;
install the second hypervisor on each of the target hosts by streaming an installation media for the second hypervisor from the coordinating host to each of the target hosts;
configure a management and orchestration service in one of the target hosts from the coordinating host; and
install the second hypervisor on the coordinating host by streaming the installation media from the management and orchestration service to the coordinating host.

11. The computer system of claim 10, wherein the coordinating host is configured to configure the management and orchestration service by:
retrieving a binary for the management and orchestration service from a cloud-based software catalog; and
deploying the binary on one of the target hosts.

12. The computer system of claim 10, wherein the coordinating host is configured to configure the management and orchestration service by:
retrieving a virtual machine for the management and orchestration service from a cloud-based software catalog; and
deploying the virtual machine on the second hypervisor of one of the target hosts.

13. The computer system of claim 10, wherein the coordinating host is further configured to:
transmit credentials of the coordinating host to the management and orchestration service after configuring the management and orchestration service.

14. The computer system of claim 13, wherein the management and orchestration service is configured to:
validate the credentials of the coordinating host prior to installing the second hypervisor on the coordinating host.

15. The computer system of claim 14, wherein each of the physical hosts further comprises a baseboard management controller, the installation media is streamed to the baseboard management controller of each of the target hosts and the coordinating host, and the credentials of the coordinating host are credentials of the baseboard management controller of the coordinating host.

16. The computer system of claim 10, further comprising:
a user device,
wherein the service request is received from the user device, and the coordinating host is further configured to:
redirect the user device from the coordinating host to the management and orchestration service after configuring the management and orchestration service.

17. The computer system of claim 10, wherein the coordinating host is further configured to:
receive the installation media for the second hypervisor from a user device; and
forward the installation media for the second hypervisor from the coordinating host to the management and orchestration service.

18. The computer system of claim 10, wherein the coordinating host is configured to install the second hypervisor by:
accessing a media endpoint for the installation media at the management and orchestration service;
mounting the installation media as a virtual media device in the coordinating host; and
rebooting the coordinating host.

19. A computer device, comprising:
a processor; and
a non-transitory computer-readable medium storing instructions which, when executed by the processor, cause the processor to:
designate one of a plurality of physical hosts as a coordinating host, wherein each of the physical hosts comprises a first hypervisor;
receive a service request to reimage target hosts of the physical hosts from the first hypervisor to a second hypervisor, the second hypervisor being different than the first hypervisor;
install the second hypervisor on each of the target hosts by streaming an installation media for the second hypervisor from the coordinating host to each of the target hosts;
configure a management and orchestration service in one of the target hosts from the coordinating host; and
install the second hypervisor on the coordinating host by streaming the installation media from the management and orchestration service to the coordinating host.

20. The computer device of claim 19, wherein the instructions further cause the processor to:
receive the installation media for the second hypervisor from a user device; and
forward the installation media for the second hypervisor from the coordinating host to the management and orchestration service.
